(19) United States
(12) Patent Application Publication
(10) Pub. No.: US 2025/0096429 A1
(43) Pub. Date: Mar. 20, 2025

(54) BATTERY MODULE, APPARATUS AND METHOD FOR MANUFACTURING BATTERY MODULE

(71) Applicant: SK on Co., Ltd., Seoul (KR)

(72) Inventors: Kwan Yong KIM, Daejeon (KR); Wook Hyun KIM, Daejeon (KR); Ju Hwan SUNG, Daejeon (KR); Yong Hun JUNG, Daejeon (KR)

(21) Appl. No.: 18/885,083

(22) Filed: Sep. 13, 2024

(30) Foreign Application Priority Data
Sep. 15, 2023 (KR) 10-2023-0123302

(51) Int. Cl. H01M 50/516; B23K 9/095; B23K 26/21; H01M 10/04; H01M 50/211; H01M 50/503

(52) U.S. Cl. CPC H01M 50/516; B23K 9/0953; B23K 26/21; H01M 10/0404; H01M 50/211; H01M 50/503

(57) ABSTRACT

Proposed is an apparatus for manufacturing a battery module that welds at least one electrode tab of a plurality of battery cells and at least one bus bar that are included in the battery module, the apparatus including a vision sensor configured to create an image by photographing a state in which the electrode tab of the battery cell is inserted in the bus bar, and a controller configured to recognize a first reference mark formed close to the hole of the bus bar in the image and determine a start point for welding the bus bar and the electrode tab on the basis of the first reference mark. Since the apparatus determines a start point of welding by recognizing a reference mark formed on a bus itself, it is possible to determine a welding position regardless of variation of lamps or the surrounding environment.

The present application claims priority to Korean Patent Applications No. 10-2023-0123302, filed Sep. 15, 2023, the entire contents of which are incorporated herein for all purposes by this reference.

### BACKGROUND

### Technical Field

The present disclosure relates to a battery module, and an apparatus and method for manufacturing a battery module.

### Description of the Related Art

The battery packs mounted on electric vehicles have a structure formed by connecting a plurality of battery cells in series and in parallel. A bus bar is used to electrically connect a plurality of battery cells of a battery pack. A bus bar is connected to an electrode tab of a battery cell, thereby transmitting a current. A bus bar can be physically fixed with an electrode tab by welding, etc. A bus bar and an electrode tab can be welded using laser welding of various types of welding.

### SUMMARY

The present disclosure provides a battery module including a structure in which an electrode tab of a battery cell and a bus bar are welded, and an apparatus and method for manufacturing a battery module, the apparatus and method performing high-quality welding.

A battery module according to an aspect of the present disclosure can be generally used in the fields of electric vehicles and battery charging stations and other fields of green technology such as photovoltaic wind power generation.

A battery module according to an aspect of the present disclosure can be used for eco-friendly electric vehicles, hybrid vehicles, etc. for preventing climate change by suppressing air pollution and emission of greenhouse gas.

A battery module according to an embodiment of the present disclosure includes: a plurality of battery cells each comprising at least one electrode tab; and at least one bus bar configured to electrically connect the at least one electrode tab of the plurality of battery cells, the bus bar includes: a plate having a first surface and a second surface that is an opposite surface to the first surface; a plurality of holes that are formed through the first surface and the second surface of the plate and in which the at least one electrode tab of the battery cells are inserted from the second surface toward the first surface; and a first reference mark formed on the first surface and formed close to the hole.

According to an embodiment, the bus bar may further include a second reference mark formed on the surface on which the first reference mark is formed, being opposite to the first reference mark with the hole therebetween, and formed parallel with the hole.

According to an embodiment, the bus bar may further include a third reference mark formed on the surface on which the first reference mark is formed and formed perpendicularly to the first reference mark.

According to an embodiment, the bus bar may further include an identification mark formed on the first reference mark.

According to an embodiment, each of the plurality of holes receives one electrode tab of the battery cell.

An apparatus for manufacturing a battery module according to an embodiment is an apparatus that welds at least one electrode tab of a plurality of battery cells and at least one bus bar that are included in the battery module, and includes: a vision sensor configured to create an image by photographing a state in which the electrode tab of the battery cell is inserted in the bus bar; and a controller configured to recognize a first reference mark formed close to the hole of the bus bar in the image and determine a start point for welding the bus bar and the electrode tab on the basis of the first reference mark.

According to an embodiment, the controller may determine a Y-axis coordinate of the start point on the basis of a Y-axis coordinate of the first reference mark in the image.

According to an embodiment, the bus bar may further include a third reference mark formed on a surface on which the first reference mark is formed and formed perpendicularly to the first reference mark, and the controller may determine an X-axis coordinate of the start point by adding a predetermined offset distance to an X-axis coordinate of the third reference mark in the image.

According to an embodiment, the bus bar may further include: a second reference mark formed on the surface on which the first reference mark is formed, being opposite to the first reference mark with the hole therebetween, and formed parallel with the hole; and an identification mark formed on any one or all of the first reference mark and the second reference mark, and the controller may recognize the first reference mark or the second reference mark by recognizing the identification mark.

According to an embodiment, the controller may recognize a point at which a color of a pixel changes while moving a first interest region in the image in a direction perpendicular to a direction in which the first reference mark is formed in order to recognize the first reference mark.

A method for manufacturing a battery module according to an embodiment is a method that welds at least one electrode tab of a plurality of battery cells and at least one bus bar that are included in the battery module, and includes: creating an image by photographing a state in which the electrode tab of the battery cell is inserted in the bus bar by means of a vision sensor; and recognizing a first reference mark formed close to the hole of the bus bar in the image on the basis of the image received from the vision sensor, and determining a start point for welding the bus bar and the electrode tab on the basis of the first reference mark by means of a controller.

According to an embodiment, the determining of a start point may determine a Y-axis coordinate of the start point on the basis of a Y-axis coordinate of the first reference mark in the image by means of the controller.

According to an embodiment, the determining of a start point may recognize a third reference mark formed perpendicularly to the first reference mark in the image and may determine an X-axis coordinate of the start point by adding a predetermined offset distance to an X-axis coordinate of the third reference mark by means of the controller.

According to an embodiment, the determining of a start point recognizes an identification mark formed on any one or all of the first reference mark and a second reference mark formed opposite to the first reference mark with the hole therebetween, thereby recognizing the first reference mark or the second reference mark by means of the controller.

According to an embodiment, the determining of a start point may recognize a point at which a color of a pixel changes while moving a first interest region in the image in a direction perpendicular to a direction in which the first reference mark is formed in order to recognize the first reference mark by means of the controller.

Features and advantages of the present disclosure will be made clearer from the following detailed description based on accompanying drawings.

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure.

According to the present disclosure, it is possible to improve the quality of welding of a bus bar and an electrode tab of a battery cell.

According to the present disclosure, it is possible to accurately determine a start point of welding by recognizing a reference mark formed on a bus bar itself.

According to the present disclosure, it is possible to recognize a reference mark by recognizing an identification mark connected to the reference mark when a plurality of reference mark is formed on a bus bar.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a view showing a battery module according to an embodiment;

FIG. 2 is a view showing a bus bar according to an embodiment;

FIG. 3 is a cross-sectional view taken along line A-A′ of FIG. 2;

FIG. 4 is a cross-sectional view showing the state in which electrode tabs of battery cells are inserted in a bus bar according to an embodiment;

FIG. 5 is a view showing an apparatus for manufacturing a battery module according to an embodiment;

FIG. 6 is a flowchart showing a method for manufacturing a battery module according to an embodiment;

FIG. 7 is a view illustrating a process of determining a start point by means of a controller on the basis of an image taken by a vision sensor according to an embodiment;

FIG. 8 is a view showing a bus bar further including a second reference mark according to an embodiment;

FIG. 9 is a view showing a bus bar further including a third reference mark according to an embodiment;

FIG. 10 is a view showing a bus bar further including an identification mark according to an embodiment.

### DETAILED DESCRIPTION

The objectives, advantages, and features of the present disclosure will be made clearer from the following detailed description and exemplary embodiments relating to the accompanying drawings, but the preset disclosure is not necessarily limited thereto. Further, in describing the present disclosure, detailed descriptions of well-known technologies will be omitted so as not to obscure the description of the present disclosure with unnecessary details.

It should be noted that when reference numerals are given to components in the drawings, the same components are given the same reference numerals even though they are shown in different drawings, and similar components are given similar reference numerals.

Terms that are used to describe an embodiment of the present disclosure are not intended to limit the present disclosure. It should be noted that singular expressions include plural expressions unless stated otherwise in the contexts.

Drawings may be schematically shown or may be exaggerated to describe embodiments.

In the specification, expressions such as “have”, “may have”, “include”, or “may include” indicate existence of corresponding characteristics (e.g., a number, a function, an operation, or a component such as a part) without excluding existence of additional characteristics.

Terms “one”, “other”, “another”, “first”, “second”, etc. are used to discriminate one component from another component and the components are not limited to the terms.

It should be understood that terms that mean direction such as “up”, “down”, “left”, “right”, “X-axis”, “Y-axis”, “Z-axis”, etc. are only for the convenience of description and may be expressed otherwise, depending on the position of an observer, the position of an object, etc.

Embodiment described herein and the accompanying drawings are not intended to limit the present disclosure to specific embodiments. It should be understood that the present disclosure includes various modifications, equivalents, and/or alternatives of embodiments.

Hereinafter, an embodiment of the present disclosure will be described in detail with reference to the accompanying drawings.

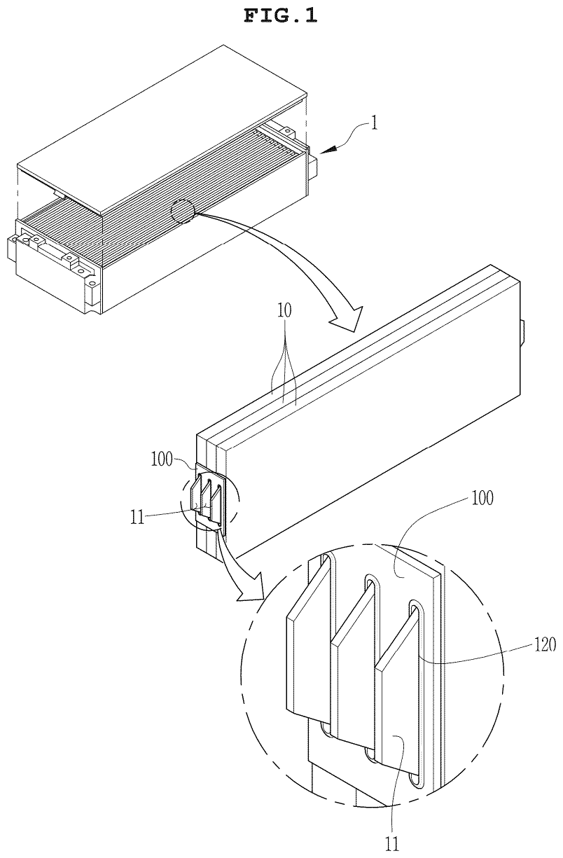

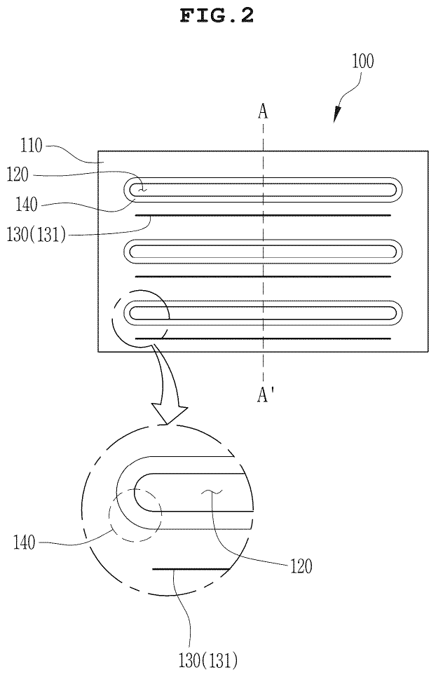

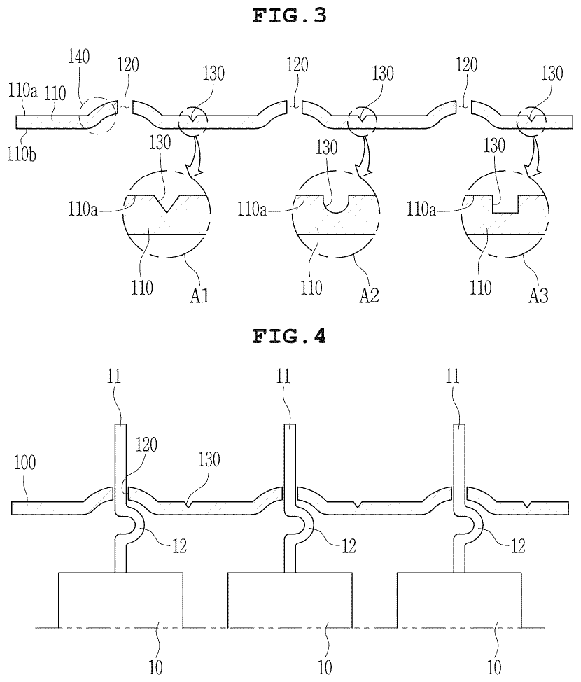

FIG. 1 is a view showing a battery module a according to an embodiment. FIG. 2 is a view showing a bus bar 100 according to an embodiment. FIG. 3 is a cross-sectional view taken along line A-A′ of FIG. 2. FIG. 4 is a cross-sectional view showing the state in which electrode tabs 11 of battery cells 10 are inserted in the bus bar 100 according to an embodiment.

A battery module 1 according to an embodiment may include a plurality of battery cells 10 each including at least one electrode tab 11, and at least one bus bar 100 electrically connecting the at least one the electrode tab 11 of the plurality of battery cells 10, and the bus bar 100 may include a plate 110 having a first surface 110a and a second surface 110b that is the opposite surface to the first surface 110a, a plurality of holes 120a that is formed through the first surface 110a and the second surface 110b and in which the at least one electrode tab 11 of the battery cells 10 are inserted from the second surface 110b toward the first surface 110a, and a first reference mark 131 formed on the first surface 110a close to the holes 120.

The battery module 1 may further include various elements other than the battery cells 10 and the bus bar 100. For example, the battery module 1 may include one or more of an HV connector, an LV connector, a voltage sensor, a current sensor, a battery module housing, and a gas venting path and may further include other elements, and known technologies may be applied to these elements.

The battery module 1 can be used as the power source of electric vehicles or can be used as a storage of electrical energy in an energy storage system (ESS). A battery pack can be formed by connecting the plurality of battery modules 1. A battery pack directly including the plurality of battery cells 10 without the battery module structure may be included in the battery module 1 of an embodiment.

The battery cell 10 may be a pouch-type battery cell. The battery cell 10 may include electrode tabs 11. The electrode tab 11 is a term meaning both of an anode electrode tab and a cathode electrode tab. As the electrode tabs 11 of the battery cell 10, as in FIG. 1, a cathode electrode tab and an anode electrode tab may be positioned on opposite sides of the battery cell 10. Alternatively, a cathode electrode tab and an anode electrode tab may be positioned on the same side. The battery cell 10 may be a secondary battery that can be charged and discharged.

The plurality of battery cells 10 may be connected by a bus bar 100. The bus bar 100 can connect the plurality of battery cells 100 in series or in parallel. The bus bar 100 may be connected with the electrode tab 11 of the battery cell 10 by welding. FIG. 1 provides an enlarged view showing the state in which three battery cells 10 are connected parallel through a bus bar 100 of a plurality of battery cells 10 and a bus bar 10 included in a battery module 1.

A bus bar 100 according to an embodiment may include a plate 110, a hole 120, and a reference mark 130. The bus bar 100 may further include protrusions 140.

The plate 110 is made of an electrical conductive material and may be formed in a thin and wide shape. When the electrode tab 11 of the battery cell 10 comes in contact with the plate 110, a current of the battery cell 10 can flow through the bus bar 100. The area or size of the plate 110 may be determined in accordance with the number and shape of the battery cells 10 that are connected to the plate 110. In order to connect three battery cells 10, as in FIG. 1, the plate 110 may be formed in a size that can connect the electrode tabs 11 of the three battery cells 10.

The hole 120 may be formed through the first surface 110a and the second surface 110b of the plate 110. A plurality of holes 120 may be formed through the plate 110. The plurality of holes 120 may be spaced apart from each other with predetermined gaps therebetween. The hole 120 may be a slit shape that is narrow and long so that the electrode tab 11 of the battery cell 10 can be inserted. The shape of the hole 120 may be determined in accordance with the shape of the electrode tab 11 of the battery cell 10. Each of the plurality of holes 120 receives one electrode tab 11 of the battery cell 10.

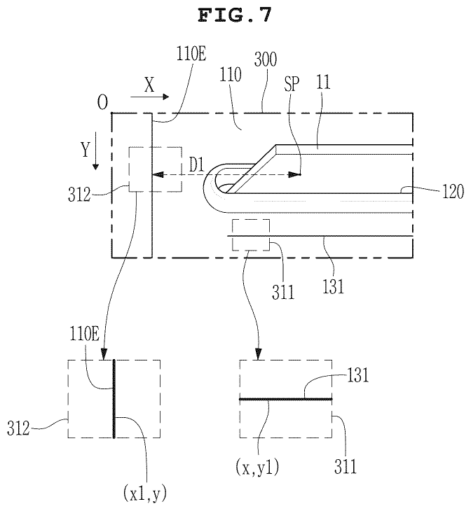

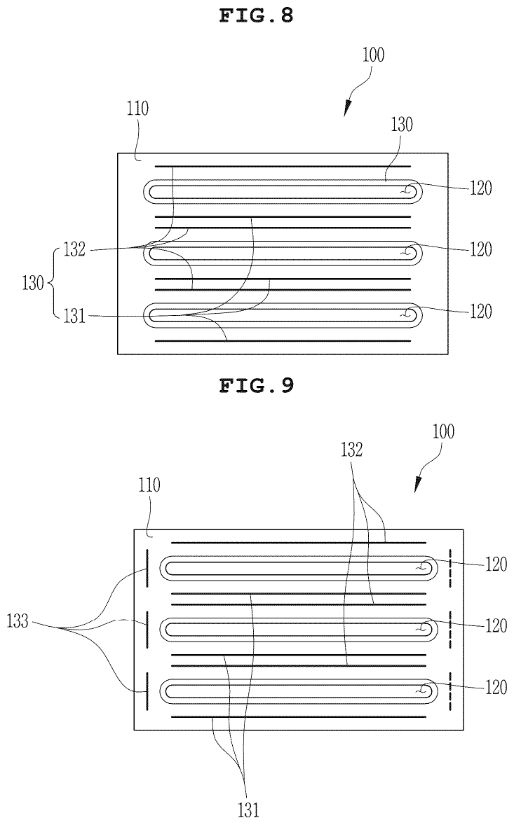

The reference mark 130 is formed on the bus bar 100 itself to determine the position of a start point SP of welding. The reference mark 130 may include first to third reference marks (a first reference mark 131 in FIG. 2 and FIG. 3, a second reference mark 132 in FIG. 7, and a third reference mark 133 in FIG. 8). The reference mark 130 is a reference that determines the position of a start point SP of welding. The first reference mark 131 or the second reference mark 132 may be used to determine the Y-axis coordinate of a start point SP of welding. The third reference mark 133 may be used to determine the X-axis coordinate of a start point SP of welding. The reference mark 131 may be referred to as an Y1 reference mark, the second reference mark 132 may be referred to as an Y2 reference mark, and the third reference mark 133 may be referred to as an X reference mark. The reference mark 133 may be a groove formed on the plate 110. The reference mark 130 may be a carved groove on the first surface of the plate 110. For example, the first reference mark 131 shown in FIG. 2 and FIG. 3 is a carved groove elongated close to (or parallel with) the hole 120. The first reference mark 131 may be formed by scratching, hitting, or pressing the first surface 110a.

Enlarged views A1, A2, and A3 in FIG. 3 are referred to. A cross-section of the reference mark 130 may be formed in a triangular shape (see the enlarged view A1), a semicircular shape (see the enlarged view A2), a rectangular shape (see the enlarged view A3), and other various shapes. When a vision sensor 210 of an apparatus 200 for manufacturing a battery module creates an image 300 by photographing the reference mark 130, it is possible to select a cross-section at which the reference mark 130 is seen as a single line in the image 300. When the reference mark 130 is seen as several lines in the image, an error may be generated in the position of a start point SP. According to an embodiment, since the reference mark 130 is formed with a cross-section at which the reference mark 130 is seen as a single line, it is possible to determine the position of a start point SP without an error.

The protrusion 140 is a portion formed by deforming a portion of the plate 110 to protrude toward the first surface 110a such that the hole 120 protrudes toward the first surface 110a. The protrusion 140 may be formed around the hole 120. The protrusion 140 may protrude toward the first surface 110a from the second surface 110b. When the electrode tab 11 of the battery cell 10 is inserted into the bus bar 100, the protrusion 140 can guide the electrode tab 11 to the hole 120.

The electrode tab 11 of the battery cell 10 may be inserted to protrude through the hole 120 of the plate 110. When the electrode tab 11 of the battery cell 10 is inserted in the hole 120 of the bus bar 100, it is possible to weld and fix the electrode tab 11 and the plate 110 by emitting a laser.

FIG. 4 is referred to. The battery cell 10 may include a bending portion formed on an electrode tab 11. The bending portion 12 may be formed by bending a portion of the electrode tab 11. The bending portion 12 may be formed in a ‘U’ shape. The bending portion 12 may be formed in various shapes. When the electrode tab 11 of the battery cell 10 is inserted in the hole 120 of the bus bar 100 until the bending portion 12 and the protrusion 140 are brought contact with each other and when the plate 110 is seated on the bending portion 12 and relative positions are fixed, the welding quality can be improved. The bending portion 12 can minimize damage to the welded portion by absorbing shock when external vibration or shock is generated with the electrode tab 11 welded with the bus bar 100.

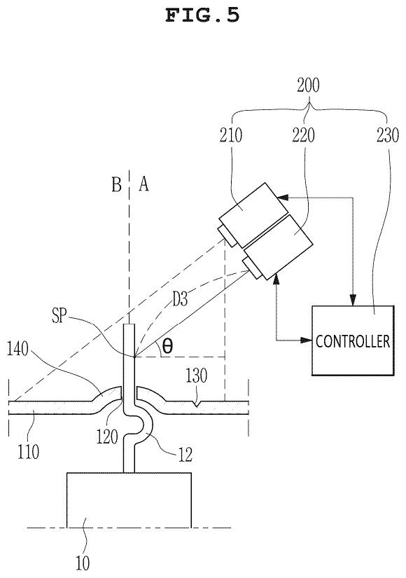

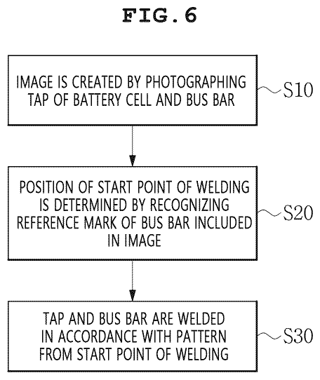

FIG. 5 is a view showing an apparatus 200 for manufacturing a battery module according to an embodiment. FIG. 6 is a flowchart showing a method for manufacturing a battery module according to an embodiment. FIG. 7 is a view illustrating a process of determining a start point SP by means of a controller 230 on the basis of an image 300 taken by a vision sensor 210 according to an embodiment. The positions of start points SP of welding shown in FIG. 5 and FIG. 7 are exemplary positions and the position of a start point SP of welding may be changed in accordance with the size or shape of the electrode tab 11 and the bus bar 100, the type of welding, etc.

An apparatus 200 for manufacturing a battery module according to an embodiment can recognize the state in which the electrode tab 11 of the battery cell 10 is inserted in the hole 120 of the bus bar 100, and can perform welding. The apparatus 200 for manufacturing a battery module is an apparatus that welds the at least one electrode tab 11 of a plurality of battery cells 10 and the at least one bus bar 100 that are included in the battery module 1. It is possible to manufacture the battery module 1 according to an embodiment using the apparatus 200 for manufacturing a battery module. The apparatus 200 for manufacturing a battery module may include a vision sensor 210 that creates an image 300 by photographing the state in which the electrode tab 11 of the battery cell 10 is inserted in the hole 120 of the bus bar 100, and a controller 230 that recognizes a first reference mark 131 formed close to the hole 120 of the bus bar 100 in the image 300 and determines a start point P for welding the bus bar 100 and the electrode tab 11 on the basis of the first reference mark 131. The apparatus 200 for manufacturing a battery module may further include a welding machine 220 that is controlled by the controller 230 and welds the electrode tab 11 and the bus bar 100 along a predetermined path from a start point SP.

The vision sensor 210 may include a camera. The vision sensor 210 can create an image 300 by photographing the state in which the electrode tab 11 of the battery cell 10 is inserted in the hole 120 of the bus bar 100 using the camera, and can transmit the image 300 to the controller 230. The vision sensor 210 may include an RGB camera, an infrared camera, and other various photographing devices. The vision sensor 210 may further include a positioner that moves the camera to desired positions such as a robot arm or a multi-axis moving frame. The vision sensor 210 can select a region to be photographed by changing the position of the camera using the positioner on the basis of control by the controller.

The vision sensor 210 can be positioned to take an image 300 toward the hole 120, in which the electrode tab 11 is inserted, at the side where the first reference mark 131 is formed. The first reference mark 131 of the bus bar 100 and the camera of the vision sensor 210 may be positioned in the same side. For example, in FIG. 5, the first reference mark 131 may be positioned at the side A from the hole 120 and the vision sensor 210 may also be positioned at the side A from the hole 120. When the first reference mark 131 of the bus bar 100 is positioned at the side B from the hole 120, the vision sensor 210 may also be disposed to take a picture toward the hole 120 at the side B from the hole 120. The camera of the vision sensor 210 can photograph the electrode tab 11 and the first reference mark 131 at a position inclined at a predetermined angle with respect to the first surface of the plate 110 and spaced a predetermined distance apart from the hole 120. A portion of an image 300 created by taking a picture toward the hole 120 through the camera of the vision sensor 210 is shown in FIG. 7. The image 300 may include the plate 110, the hole 120, and the protrusion 140 of the bus bar 100, an edge 110E of the plate 110, and the electrode tab 11 of the battery cell 10, and the camera can be positioned to be able to obtain this image 300.

The welding machine 220 can weld the electrode tab 11 and the bus bar 1200 on the basis of control by the controller 230. The welding machine 220 may include a laser welding machine, an ultrasonic welding machine, and other various types of welding machine. For example, the welding machine 220 may include a laser welding machine. The welding machine 220 may include a moving unit that moves the laser welding machine along desired paths such as a robot arm or a multi-axis moving frame. The welding machine 220 can move the laser welding machine using the moving unit such that welding is performed from a start point SP of welding to an end point along a pattern.

The welding machine 220 may be positioned at the same side as the vision sensor 210 to face the electrode tab 11. The laser welding machine of the welding machine 220 may be positioned to face the electrode tab 11 inserted in the hole 120 at the side where the first reference mark 131 is formed. The protruding side of the bending portion 12 of the electrode tab 11, the side at which the first reference mark 131 is formed, the side at which the welding machine 220 is positioned, and the side at which the vision sensor 210 is positioned with respect to the hole 120 may be the same. For example, in FIG. 5, the first reference mark 131, the protruding side of the bending portion 12, and the position of the welding machine 220 are positioned at the side A from the hole 120. When the first reference mark 131 of the bus bar 100 is positioned at the side B from the hole 120, the welding machine 220 and the protruding direction of the bending portion 12 may also be positioned at the side B from the hole 120. The laser welding machine of the welding machine 220 may face the electrode tab 11 at a position inclined at a predetermined angle θ with respect to the first surface 110a of the plate 110 of the bus bar 100 and spaced a predetermined distance D3 from a start point SP of welding. A laser is emitted to the electrode tab 11, thereby being able to weld the electrode tab 11 and the bus bar 100.

However, the direction of the bending portion 12 and the directions of the vision sensor 210 and the welding machine 220 are not necessarily the same. When the bending portion 12 protrude to the side A, the first reference mark 131, the vision sensor 210, and the welding machine 220 may be positioned at the side B.

A method for manufacturing a battery module according to an embodiment may include a process in which the controller 230 controls the vision sensor 210 to photograph the electrode tab 11 and the bus bar 100, determines the position of a start point SP of welding by analyzing an image 300 received from the vision sensor 210, and controls the welding machine 220 to weld the electrode tab 11 and the bus bar 100.

The method for manufacturing a battery module is a method that welds the at least one electrode tab 11 of a plurality of battery cells 10 and the at least one bus bar 100 that are included in the battery module 1. It is possible to manufacture the battery module 1 according to an embodiment using the method for manufacturing a battery module. The method for manufacturing a battery module may include creating an image by photographing the state in which the electrode tab 11 of the battery cell 10 is inserted in the hole 120 of the bus bar by means of the vision sensor 210 (S10), and recognizing a first reference mark 131 formed close to the hole 120 of the bus bar 100 in the image 300 on the basis of the image 300 received from the vision sensor 210 and determining a start point SP for welding the bus bar 100 and the electrode tab 11 on the basis of the first reference mark 131 (S20). The method for manufacturing a battery module may further include welding the electrode tab 11 and the bus bar 100 in accordance with a predetermined pattern from the determined start point SP of welding by means of the welding machine 220 on the basis of control by the controller 230.

The creating of an image 300 (S10) is to create an image 300 by photographing the electrode tab 11 of the battery cell 10 and the bus bar 100 by means of the vision sensor 210. In the creating of an image 300 (S10), the vision sensor 210 can position the camera to face the electrode tab 11 and the hole 120 to be welded and can create an image including the plate 110, the hole 120, and the protrusion 140 of the bus bar 100, an edge 110E of the plate 110, and the electrode tab 11 of the battery cell 10 on the basis of control by the controller 230, The vision sensor 210 can transmit the created image 300 to the controller 230.

The determining of a start point SP (S20) is to determine a start point SP of welding by recognizing a reference mark 130 of the bus bar 100 included in the image 300 received from the vision sensor 210 by means of the controller 230. The controller 230 can control the welding machine 220 to perform welding from the start point SP to an end point in accordance with a predetermined pattern after determining the start point SP.

The welding of the electrode tab 11 and the bus bar 100 (S30) is to weld the electrode tab 11 and the bus bar 100 while moving a laser welding machine in accordance with a predetermined pattern from the start point SP of welding by means of the welding machine 220 on the basis of control by the controller 230. In the welding of the electrode tab 11 and the bus bar 100 (S30), the welding machine 220 can output a laser and move the laser welding machine such that welding is started from the determined start point SP, continued in accordance with a pattern, and finished at an end point.

The determining of a start point SP (S20) is described with reference to FIG. 7.

In the determining of a start point SP (S20), the controller 230 can determine the position of a start point SP for welding the electrode tab 11 and the bus bar 100 on the basis of the position of a reference mark 130 seen in the image 300. The controller 230 can recognize a first reference mark 131 and an edge 110E of the plate 110. The first reference mark 131 is used to determine the Y-axis position of a start point SP of welding. The edge 110E of the plate is used to determine the X-axis position of a start point SP of welding.

The controller 230 can set a corner of the image 300 as an origin and obtain the coordinates of the reference mark 130 and the edge 110E of the plate 110 in an X-Y coordinate system. The controller 230 selects a first interest region 311 and a second interest region 312 in the image 300 and senses pixel variation of the image 300 included in the interest regions 311 and 312, thereby being able to recognize the first reference mark 131 and the edge 110E of the plate 110. The first interest region 311 of the image 300 is a part in which the first reference mark 131 is seen. The second interest region 312 of the image 300 is a part in which the edge 110E of the plate 110 is seen. Since the distance and the angle between the bus bar 100 and the vision sensor 210 are set, it is possible to determine the first and second interest regions 311 and 312 in advance to correspond to the positions at which the reference mark 130 and the edge 110E of the plate 110 are seen in the image 300. The processing speed can be improved when the controller 230 recognizes the reference mark 130 and the edge 110E of the plate 110 by analyzing only the predetermined interest regions 311 and 312 in comparison to analyzing the entire of the image 300.

The controller 230 can recognize a first reference mark 131 seen in the first interest region 311. In the determining of a start point SP (S20), the controller 230 can recognize a point at which the color of a pixel changes while moving the first interest region 311 in the image 300 in a direction perpendicular to the direction in which the first reference mark 131 is formed in order to recognize the first reference mark 131. A line or a point at which the color of a pixel of the pixels included in the first interest region 311 changes along the Y-axis is recognized as the first reference mark 131. In this case, the X-axis position of the first interest region 311 may be determined in advance. The controller 230 can obtain the Y-axis coordinate y1 of the first reference mark 131 in the first interest region 311. y1 is the distance from the origin to the first reference mark 131.

The controller 230 can recognize the edge 110E of the plate 110 seen in the second interest region 312. In the determining of a start point SP (S20), the controller 230 can recognize a point at which the color of a pixel changes while moving the second interest region 312 in the image 300 in a direction perpendicular to the longitudinal direction of the edge 110E of the plate 110 in order to recognize the edge 110E of the plate 110. A line or a point at which the color of a pixel of the pixels included in the second interest region 312 changes along the X-axis is recognized as the edge 110E of the plate 110. In this case, the Y-axis position of the second interest region 312 may be determined in advance. The controller 230 can obtain the X-axis coordinate x1 of the edge 110E of the plate 110 seen in the second interest region 312. x1 is the distance from the origin to the edge 110E of the plate 110.

In short, the controller 230 can find out a line-shaped pattern in the interest regions 311 and 312 and recognize the X-axis coordinate or the Y-axis coordinate of the line-shaped pattern. The controller 230 can recognize the Y-axis coordinate of a line elongated along the X-axis in the image 300 and the X-axis coordinate of a line elongated along the Y-axis in the image 300. Since the first reference mark 131 is a line elongated along the X-axis in the image 300, the controller 230 can recognize the Y-axis coordinate of the first reference mark 131. Since the edge 110E of the plate 110 is a line elongated along the Y-axis in the image 300, the controller 230 can recognize the X-axis coordinate of the edge 110E of the plate 110.

In the determining of a start point SP (S20), the controller 230 can determine the Y-axis coordinate of the start point SP on the basis of the Y-axis coordinate of the first reference mark 131 in the image 300. The Y-axis coordinate of the start point SP may be determined as any point on the electrode tab 11 protruding over the bus bar 100.

The controller 230 can determine the X-axis coordinate of a start point SP by adding a predetermined offset distance D1 to the X-axis coordinate x1 of the edge 110E of the plate 110. For example, when the origin is the left upper corner and the X-axis goes to the right in the image 300 in FIG. 7, the controller 230 can determine the X-axis coordinate of a start point SP by adding a predetermined offset distance D1 to the X-axis coordinate x1 of the edge 110E of the plate 110. The offset distance D1 is a value stored in advance in the controller 230. The offset distance D1 is a value that is determined in advance after the size of the bus bar 100, the position of the hole 120, the shape of the electrode tab 11, a welding pattern, etc. are determined.

In the determining of a start point SP (S20), the controller 230 can determine the X-axis coordinate and the Y-axis coordinate of a start point SP by performing the process described above.

FIG. 8 is a view showing a bus bar 100 further including a second reference mark 132 according to an embodiment.

The bus bar 100 according to an embodiment may further include a second reference mark 132 that is formed on the surface on which the first reference mark 131 is formed, is opposite to the first reference mark 131 with the hole 120 therebetween, and is parallel with the hole 120. The second reference mark 132 may be a groove carved on the first surface 110a of the plate 110, the same as the first reference mark 131. The second reference mark 132 may have a width and a length that are the same as those of the first reference mark 131. The second reference mark 132 may be spaced apart from the hole 120 with a predetermined gap therebetween.

According to the bus bar 100 on which the first reference mark 131 and the second reference mark 132 are formed in the same shape at both sides of the hole 120, the vision sensor 210 can take an image 300 at both sides of the hole 120 and the welding machine 220 can weld the bus bar 100. The controller 230 may recognize a reference mark 130 that is seen close in the image 300 as a first reference mark 131 and a reference mark 130 that is seen far in the image 300 as a second reference mark 132. When the available welding directions are limited by the relative arrangement structure of the bus bar 100 and battery cell 10 or the relationships with the battery module or other parts of the battery pack, it is possible to use the bus bar 100 having both the first reference mark 131 and the second reference mark 132.

FIG. 9 is a view showing a bus bar 100 further including a third reference mark 133 according to an embodiment.

The bus bar 100 according to an embodiment may further include a third reference mark 133 that is formed on the surface on which the first reference mark 131 is formed and is formed perpendicularly to the first reference mark 131. The third reference mark 133 may be used as a reference for determining the X-axis coordinate of a start point SP instead of the edge 110E of the plate 110. The third reference mark 133 may be a groove that is spaced apart from the hole 120 by a predetermined gap, is formed perpendicularly to the first reference mark 131, and is carved on the first surface 110a of the plate 110.

The controller 230 can recognize a third reference mark 133 seen in the second interest region 312. The controller 230 can recognize a point at which the color of a pixel changes along the X-axis in the second interest region 312 as the third reference mark 133. The controller 230 can recognize a point at which the color of a pixel changes along the X-axis as the third reference mark 133 while moving the second interest region 312 in the image 300. In this case, the Y-axis position of the second interest region 312 may be determined in advance.

In the determining of a start point SP (S20), the controller 230, in the image 300, can recognize the third reference mark 133 formed perpendicularly to the first reference mark 131 and determine the X-axis coordinate of a start point SP by adding a predetermined offset distance to the X-axis coordinate of the third reference mark 133. The distance from the third reference mark 133 to a start point SP of welding may be determined and stored in advance in the controller 230.

The third reference mark 133 may be formed at one side or both sides of the hole 120. FIG. 9 shows a bus bar 100 having a third reference mark 133 at only one side. When the third reference mark 133 is formed at both sides, the third reference mark 133 is formed at both sides of the hole 120 and the positions is shown by dotted lines in FIG. 9.

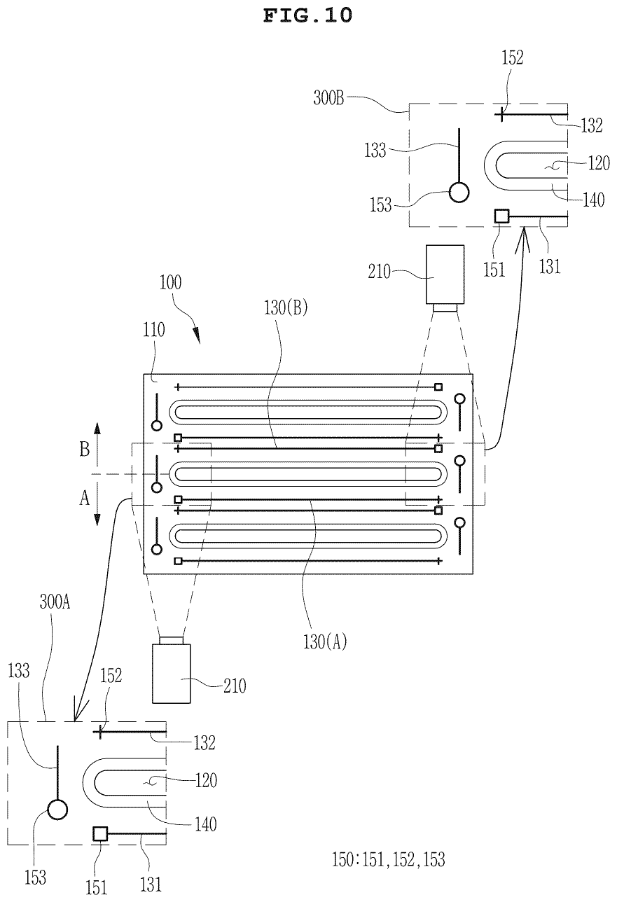

FIG. 10 is a view showing a bus bar 100 further including identification mark 150 according to an embodiment.

The bus bar 100 according to an embodiment may further include an identification mark 150 that is formed on the first reference mark 131. The bus bar 100 may further include identification marks 150 formed on the second reference mark 132 and the third reference mark 133. The identification mark 150 may be formed on at least one or more of the first reference mark 131, the second reference mark 132, and the third reference mark 133.

A first identification mark 151 that is formed on the first reference mark 131, a second identification mark 152 that is formed on the second reference mark 132, and a third identification mark 153 that is formed on the third reference mark 133 may be differently formed. For example, the first identification mark 151 that is formed on the first reference mark 131 may be a rectangle and may be formed on a side of the first reference mark 131. The second identification mark 152 that is formed on the second reference mark 132 may be a cross and may be formed on a side of the second reference mark 132. The third identification mark 153 that is formed on the third reference mark 133 may be a circle and may be formed on a side of the third reference mark 133. That is, identification marks may be differently formed, depending on reference marks.

The bus bar 100 may further include a second reference mark 132 formed on the surface on which the first reference mark 131 is formed, being opposite to the first reference mark 131 with the hole 120 therebetween, and formed parallel with the hole 120, and an identification mark 150 formed on any one or all of the first reference mark 131 and the second reference mark 132, and the controller 230 can recognize the first reference mark 131 or the second reference mark 132 by recognizing the identification mark 150.

In the determining a start point SP (S20), the controller 230 recognizes the identification mark 150 formed on any one or all of a first reference mark 131 and a second reference mark 132 formed at the opposite side to the first reference mark 131 with the hole 120 therebetween, thereby being able to recognize the first reference mark 131 or the second reference mark 132.

When the reference mark 130 is formed as a simple line, the first reference mark 131 and the second reference mark 132 may be equally seen as lines in an image 300. The controller 230 can recognize whether a line is the first reference mark 131 or the second reference mark 132 by recognizing the identification mark 150. That is, when a plurality of reference marks 131 and 132 is formed on the bus bar 100, it is possible to recognize the reference marks by recognizing the identification marks 151 and 152 connected to the reference marks. The controller 230 can recognize a shape the same as the first identification mark 151 formed on the first reference mark 131, recognize the line connected to the shape as the first reference mark 131, and obtain the Y-axis coordinate. The controller 230 can recognize a shape the same as the second identification mark 152 formed on the second reference mark 132 and recognize the line connected to the shape as the second reference mark 132. The controller 230 can recognize a shape the same as the third identification mark 153 formed on the third reference mark, recognize the line connected to the shape as the third reference mark, and obtain the X-axis coordinate.

When the first reference mark 131 and the second reference mark 132 are both formed on the bus bar 100, the first reference mark 131 and the second reference mark 132 may be changed, depending on at what sides of the hole 120 pictures are taken. For example, when a picture is taken at the side A in FIG. 10, the reference mark 130A close to the vision sensor 210 may be the first reference mark 131, and when a picture is taken at the side B, the reference mark 130B close to the vision sensor 210 may be the first reference mark 131. In this case, different identification marks 150 may be formed on both sides of the reference marks 130 facing each other with the hole 120 therebetween.

In other words, a rectangular identification mark 150 may be formed on a first side of the first reference mark 131 close to the camera on the basis of the hole 120 and a cross identification mark 150 may be formed on a second side of the first reference mark 131; and a cross identification mark 150 may be formed on a first side of the second reference mark 132 far from the camera on the basis of the hole 120 and a rectangular identification mark 150 may be formed a second side of the second reference mark 132.

A circular identification mark 150 may be formed on a first side of the third reference mark 133 at the left side in FIG. 10 on the basis of the hole 120 and an identification mark 150 may not be formed on a second side of the third reference mark 133; and an identification mark 150 may not be formed on a first side of the third reference mark 133 at the right side in FIG. 10 and a circular identification mark 150 may be formed on a second side of the third reference mark 133.

That is, reference marks 130 and identification marks 150 may be formed such that the same patterns are seen even though the marks are rotated 180 degrees around the hole 120.

An image 300A created by photographing the left side of the hole 120 at the side A by means of the vision sensor 210 and an image 300B created by photographing the left side of the hole 120 at the side B by means of the vision sensor 210 are the same, the controller 230 can determine a start point SP of welding regardless of directions. Further, when the bus bar 100 is coupled to the electrode tab 11 of the battery cell 10, the same reference mark 130 and identification mark 150 are not changed even though the bus bar 100 is rotated 180 degrees, so the problem of wrong coupling is prevented.

The apparatus 200 and method for manufacturing a battery module according to an embodiment described above determine a start point SP of welding by recognizing a reference mark 130 formed on a bus bar 100 itself, so it is possible to minimize the influence by shadows due to the surrounding lamps or light. For example, when the position of an electrode tab 11 or a hole 120 is simply recognized, there is a possibility that a shadow is made in accordance with the positions of lamps or the position of the electrode tab 11, the position of the hole 120 is obtained wrong, and welding is performed at wrong position, but, according to the method of recognizing a reference mark 130, as in an embodiment, a reference mark 130 is formed at a predetermined distance from a hole 120 on a bus bar 100 itself, so there is the advantage that it is possible to accurately determine a start point SP of welding. When a start point SP of welding is accurately determined, the quality of welding can also be improved and become uniform.

The present disclosure was described above in detail through detailed embodiments. The above description is only an example to which the principle of the present disclosure has been applied and other components may be further included without departing from the scope of the present disclosure.

What is claimed is:

1. A battery module comprising:
a plurality of battery cells each comprising at least one electrode tab; and
at least one bus bar configured to electrically connect the at least one electrode tab of the plurality of battery cells,
wherein the bus bar comprises:
a plate having a first surface and a second surface that is an opposite surface to the first surface;
a plurality of holes that are formed through the first surface and the second surface of the plate and in which the at least one electrode tab of the battery cells are inserted from the second surface toward the first surface; and
a first reference mark formed on the first surface and formed close to the hole.

2. The battery module of claim 1, wherein the bus bar further comprises a second reference mark formed on the surface on which the first reference mark is formed, being opposite to the first reference mark with the hole therebetween, and formed parallel with the hole.

3. The battery module of claim 1, wherein the bus bar further comprises a third reference mark formed on the surface on which the first reference mark is formed and formed perpendicularly to the first reference mark.

4. The battery module of claim 2, wherein the bus bar further comprises an identification mark formed on the first reference mark.

5. The battery module of claim 1, wherein each of the plurality of holes receives one electrode tab of the battery cell.

6. An apparatus for manufacturing a battery module that is an apparatus that welds at least one electrode tab of a plurality of battery cells and at least one bus bar that are included in the battery module, the apparatus comprising:
a vision sensor configured to create an image by photographing a state in which the electrode tab of the battery cell is inserted in the bus bar; and
a controller configured to recognize a first reference mark formed close to the hole of the bus bar in the image and determine a start point for welding the bus bar and the electrode tab on the basis of the first reference mark.

7. The apparatus of claim 6, wherein the controller determines a Y-axis coordinate of the start point on the basis of a Y-axis coordinate of the first reference mark in the image.

8. The apparatus of claim 6, wherein the bus bar further comprises a third reference mark formed on a surface on which the first reference mark is formed and formed perpendicularly to the first reference mark, and
the controller determines an X-axis coordinate of the start point by adding a predetermined offset distance to an X-axis coordinate of the third reference mark in the image.

9. The apparatus of claim 6, wherein the bus bar further comprises:
a second reference mark formed on the surface on which the first reference mark is formed, being opposite to the first reference mark with the hole therebetween, and formed parallel with the hole; and
an identification mark formed on any one or all of the first reference mark and the second reference mark, and
the controller recognizes the first reference mark or the second reference mark by recognizing the identification mark.

10. The apparatus of claim 6, wherein the controller recognizes a point at which a color of a pixel changes while moving a first interest region in the image in a direction perpendicular to a direction in which the first reference mark is formed in order to recognize the first reference mark.

11. A method for manufacturing a battery module that is a method that welds at least one electrode tab of a plurality of battery cells and at least one bus bar that are included in the battery module, the method comprising:
creating an image by photographing a state in which the electrode tab of the battery cell is inserted in the bus bar by means of a vision sensor; and
recognizing a first reference mark formed close to the hole of the bus bar in the image on the basis of the image received from the vision sensor, and determining a start point for welding the bus bar and the electrode tab on the basis of the first reference mark by means of a controller.

12. The method of claim 11, wherein the determining of a start point determines a Y-axis coordinate of the start point on the basis of a Y-axis coordinate of the first reference mark in the image by means of the controller.

13. The method of claim 11, wherein the determining of a start point recognizes a third reference mark formed perpendicularly to the first reference mark in the image and determines an X-axis coordinate of the start point by adding a predetermined offset distance to an X-axis coordinate of the third reference mark by means of the controller.

14. The method of claim 11, wherein the determining of a start point recognizes an identification mark formed on any one or all of the first reference mark and a second reference mark formed opposite to the first reference mark with the hole therebetween, thereby recognizing the first reference mark or the second reference mark by means of the controller.

15. The method of claim 11, wherein the determining of a start point recognizes a point at which a color of a pixel changes while moving a first interest region in the image in a direction perpendicular to a direction in which the first reference mark is formed in order to recognize the first reference mark by means of the controller.
